(19) United States
(12) Patent Application Publication
(10) Pub. No.: US 2015/0171536 A1
(43) Pub. Date: Jun. 18, 2015

(54) Shielded Flexible Circuit Connector

(71) Applicant: FCI Asia Pte. Ltd., Singapore (SG)

(72) Inventors: Yasutoshi Kameda, Kisarazu-shi (JP); Motomu Kajiura, Tokyo (JP); Masashiko Motoyama, Kanagawa (JP)

(21) Appl. No.: 14/418,485

(22) PCT Filed: Aug. 2, 2013
(86) PCT No.: PCT/SG2013/000326

§ 371 Date: Jan. 30, 2015

(30) Foreign Application Priority Data
Aug. 3, 2012 (SG) 201205799-8

(51) Int. Cl. H01R 12/77; H01R 12/79; H01R 12/78

(52) U.S. Cl. CPC H01R 12/774; H01R 12/775; H01R 12/78; H01R 12/79

(57) ABSTRACT

An electrical connector for connecting to a flexible/flat circuit board includes a housing having a cavity, contacts disposed in the cavity of the housing, and a metal shield mounted to the housing. Locking members are attached to the housing and having resilient locking projections disposed in the cavity. When a flexible/flat circuit is inserted into the cavity, openings/notches formed on the flexible/flat circuit are engaged with the locking projections such that the flexible/flat circuit is secured to the housing. The shield is rotatable relative to the housing and engaging to the locking members. When at an open position, the shield presses against the locking members to deflect and push the locking projections away from the cavity such that the flexible/flat circuit is disengaged from the locking projections and can be detached from the connector.

### TECHNICAL FIELD

The present invention relates to an electrical connector. In particular, the present invention relates to an electrical connector for connecting a flexible circuit to a printed circuit board.

### BACKGROUND

Electrical connectors for flexible circuit are widely used in electronic devices and systems. To improve the electrical connectivity, reliability and ease of assembling there is often a requirement to lock the flexible circuit to the connector. Known electrical connectors for flexible circuit have complicated structures or assembly operation in order to ensure the effectiveness of locking. For applications in compact sized devices the physical dimension of both the connector and the flexible circuits are very small, rendering the locking mechanisms of known connectors unsuitable. It is therefore desirable to provide an electrical connector for flexible circuits of miniature sizes.

### SUMMARY

An electrical connector for connecting to a flexible/flat circuit board includes a housing having a cavity, contacts disposed in the cavity of the housing, and a metal shield mounted to the housing. The cavity is configured to receive a flexible/flat circuit board, or a portion thereof, inserted from a front side of the housing. Locking members are attached to the housing and having resilient locking projections disposed in the cavity. When a flexible/flat circuit is inserted into the cavity, openings/notches formed on the flexible/flat circuit are engaged with the locking projections such that the flexible/flat circuit is secured to the housing. The shield is rotatable relative to the housing and engaged to the locking members. When rotating towards an open position, the shield presses against the locking members to deflect and push the locking projections away from the cavity by which the flexible/flat circuit is disengaged from the locking projections and can be detached from the connector.

### BRIEF DESCRIPTION OF THE DRAWINGS

These and other aspects of the present invention will be described in detail with reference to the accompanying drawings, in which:

FIG. 1 is a perspective view showing a flexible circuit connector according to one embodiment of the present invention;

FIG. 2 is a perspective view showing the connector of FIG. 1 to which a flexible circuit board is connected;

FIG. 3 is an exploded perspective view of FIG. 2;

FIG. 4 is an exploded perspective view of FIG. 2 viewing from another angle;

FIG. 5 is an enlarged cross sectional view of FIG. 1 along A-A;

FIG. 6 is an enlarged partial view of FIG. 4;

FIG. 7 is an enlarged perspective view showing a rear side of a flexible circuit connector shown FIG. 1;

FIG. 8 is a partial cross sectional view of FIG. 7 along B-B;

FIG. 9 is a perspective view of FIG. 2 without showing the housing;

FIG. 10 is a perspective view of FIG. 1 when the shield is at the open position;

FIG. 11 is a partial enlarged view of FIG. 10;

FIG. 12 is a partial cross sectional view of FIG. 10 along C-C;

FIG. 13 is a partial cross sectional view of FIG. 10 along D-D;

FIG. 14 is a perspective rear view of FIG. 1;

FIG. 15 is a cross sectional view of FIG. 14 along E-E;

FIG. 16 is a perspective view showing the structure of locking members and ground bar in a flexible circuit connector according to another embodiment of the present invention;

FIG. 17 is a perspective view showing a locking member in a flexible circuit connector according to a further embodiment of the present invention;

FIG. 18 and FIG. 19 show various types of flexible/flat circuit boards or ribbons being engaged with the locking projections of flexible circuit connector according to an embodiment of the present invention.

### DETAILED DESCRIPTION OF PREFERRED EMBODIMENTS

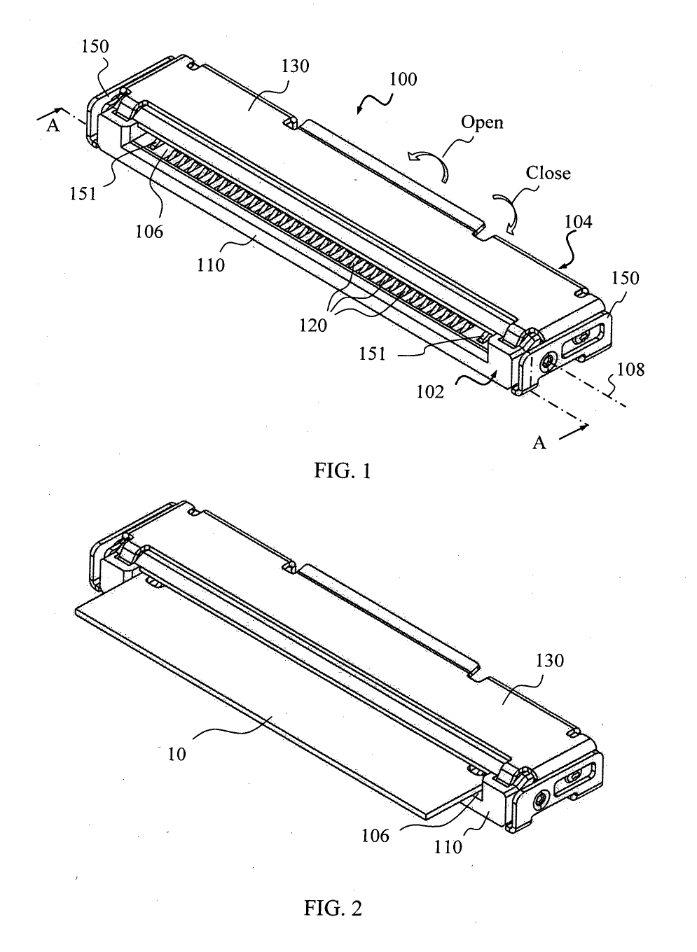

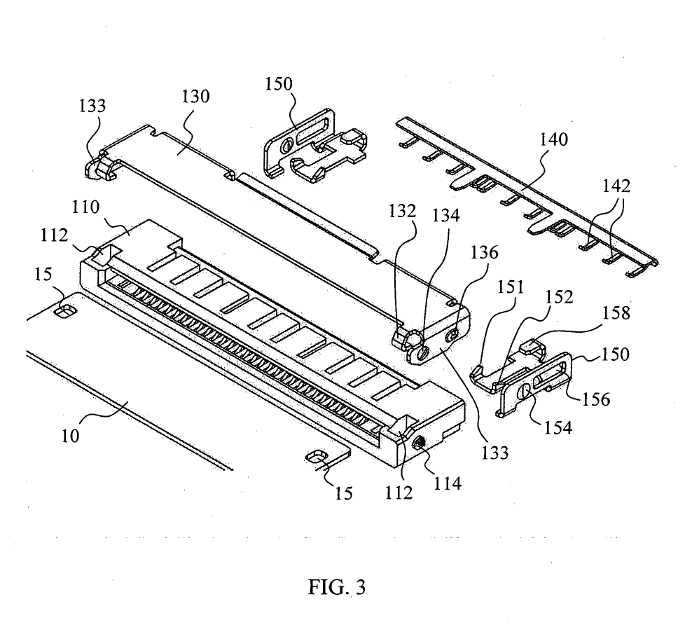

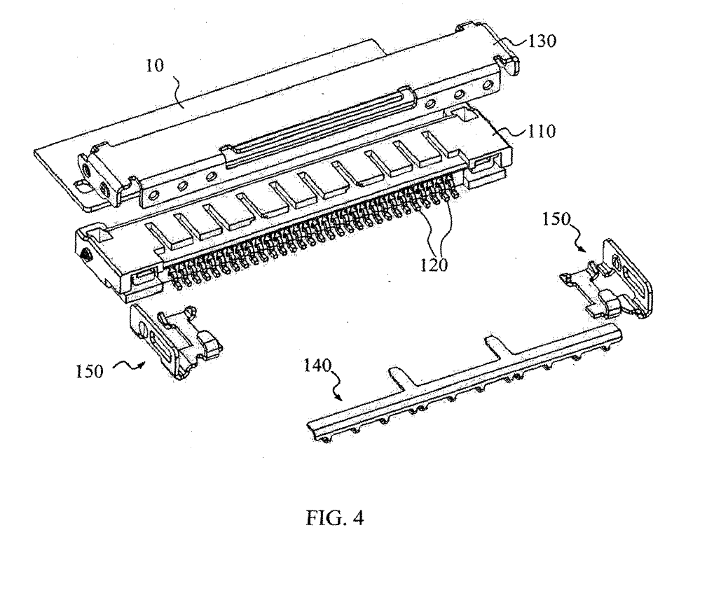

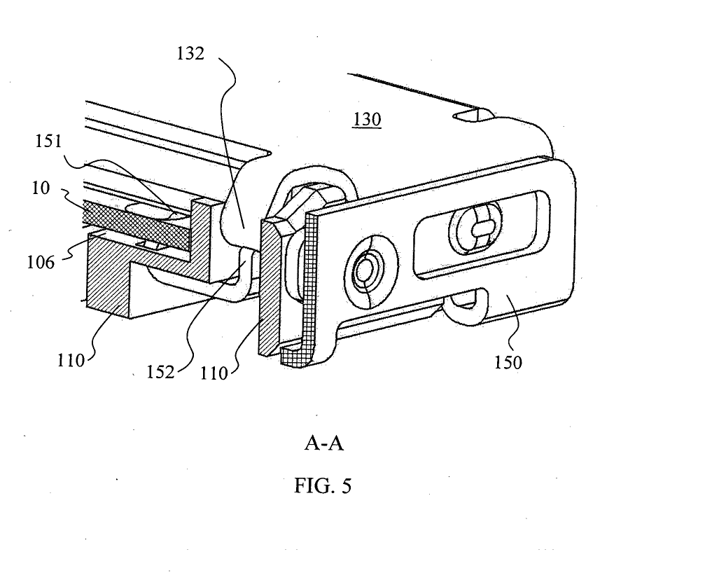

As shown in FIGS. 1 to 5, an electrical connector 100 for connecting to a flexible circuit board 10 includes a housing 110 and contacts 120 disposed in housing 110. Housing 110 has a front side 102 and an opposite rear side 104. A cavity 106 is formed in housing 110 and opens to front side 102, for receiving flexible circuit board 10 therein, to establish electrical connection with contacts 120. On top of housing 110 there is mounted a metal shield 130 which serves to reduce electromagnet effect and to improve the signal transmission speed for connector 100.

Shield 130 has a pair of sidewalls 133 bent perpendicularly from a middle portion 131. Each sidewall 133 has formed thereon a pivot bearing 134 and a locking boss 136. Shield 130 is mounted to housing 110 by the engagement of pivot bearings 134 to a pair of pivot protuberances 114 formed on housing 110. Mounted to housing 110 in this way, shield 130 becomes rotatable about an axis of rotation 108 defined by the engagement of pivot bearing 134 and pivot protuberance 114 between a close position and an open position. Further, shield 130 has a pair of releasing members 132, each of which is disposed in a release opening 112 formed on housing 110. When shield 130 rotates, releasing members 132 become movable within release opening 112.

Connector 100 includes a pair of fixing tabs 150, made of metal for instance. Fixing tabs 150 are each mounted to a left and a right side of housing 110. Each fixing tab 150 has a support plate 153 attached to one side surface of housing 110. Formed on support plate 153 there is a pivot support 154 and a locking support 156. Pivot support 154 is in alignment with a corresponding pivot protuberance 114, to form a pivot shaft coupled to pivot bearing 134, to support the rotation of shield 130. Locking support 156 is in the form of an opening and is engaged with locking boss 136 to secure shield 130 at the close position.

Each fixing tab 150 is formed integral to a locking member 155, via a link piece 157. Locking member 155 has a locking projection 151 and a release projection 152 formed at one end. At the opposite end of locking member 155, there is formed a holding piece 158.

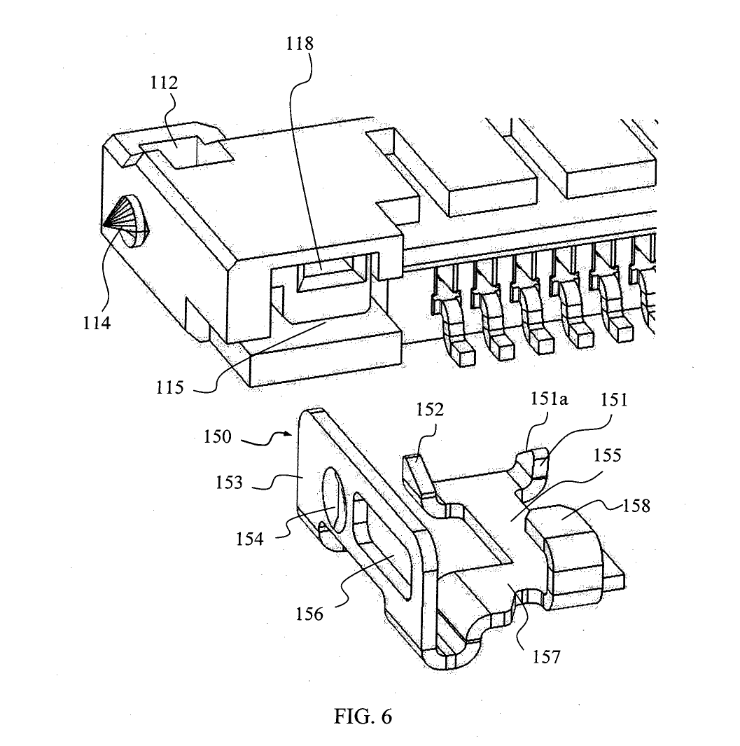

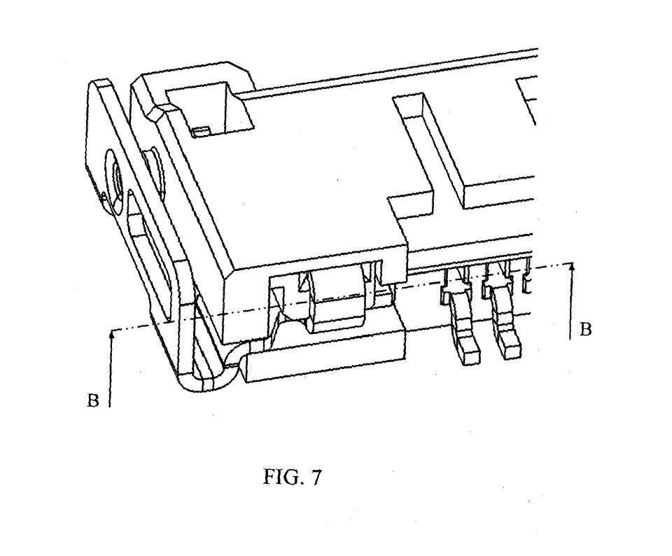

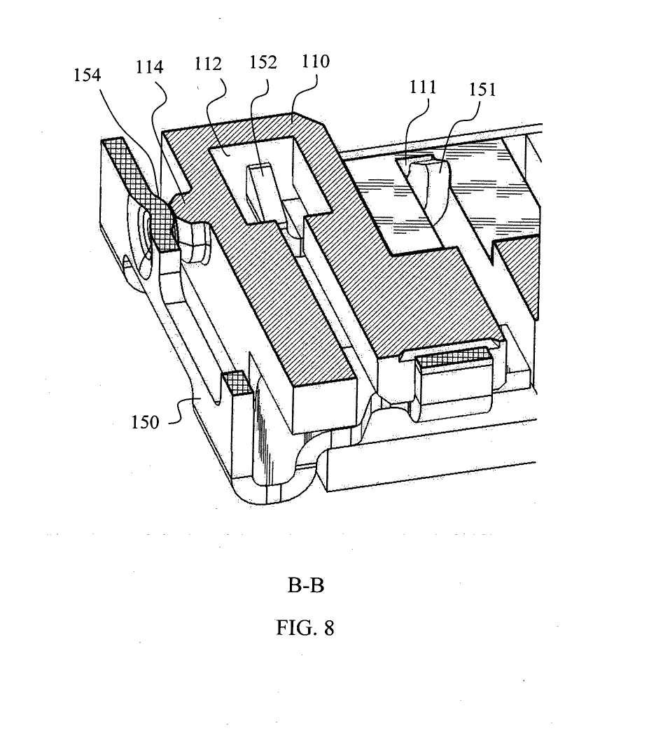

As show in FIGS. 6 to 8, when fixing tab 150 is attached to housing 110, locking member 155 is disposed in a mounting groove 115 of housing 110, and with holding piece 158 inserted into mounting recess 118 of housing 110. In the meantime, locking projection 151 extends into cavity 106, and releasing projection 152 being disposed in release opening 112 of housing 110.

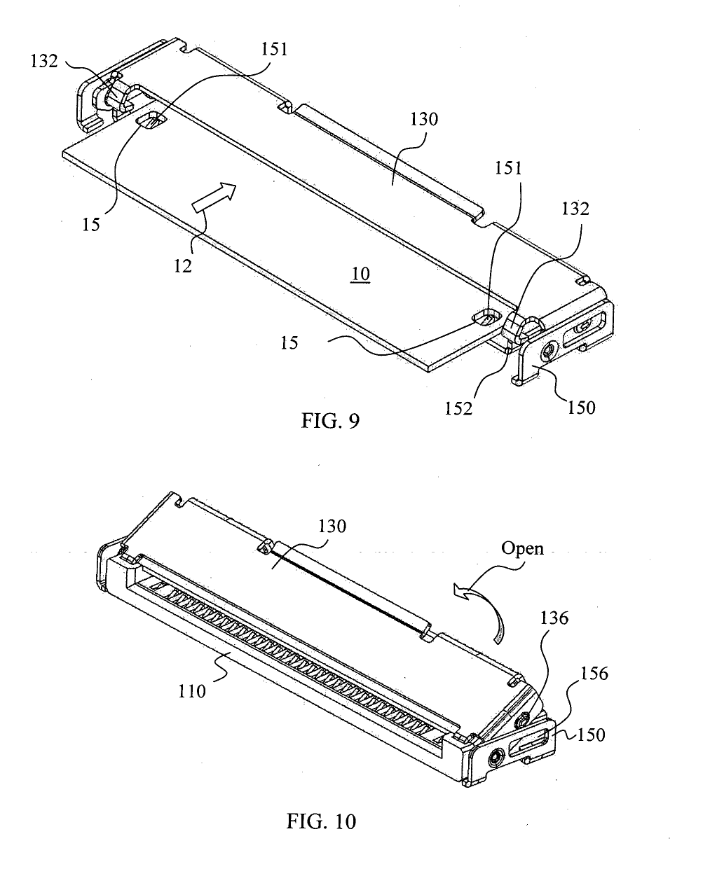

When it is desired to connect a flexible flat circuit board or ribbon 10 to connector 100, as shown in FIG. 9, shield 130 is at the close position at which, no substantial pressure is added to release projections 152 by release members 132, such that locking projections 151 are positioned in cavity 106.

Flexible/flat circuit board or ribbon 10 is then inserted along insertion direction 12 into cavity 106 during which, flexible flat circuit board or ribbon 10 is brought into contact with, and presses against, inclined front surface 151a of locking projection 151. Locking projections 151 are deflected away from cavity 106 to allow flexible/flat circuit board or ribbon 10 to pass over. Further insertion of flexible/flat circuit board or ribbon 10 will cause openings 15 to be in alignment with locking projections 151, allowing locking projections 151 to spring back to their original positions to engage openings 15 of flexible/flat circuit board or ribbon 10. By this engagement, flexible/flat circuit board or ribbon 10 is locked in cavity 106 by locking projections 151, and is prevented from being detached from connector 100. Electrical connections between flexible/flat circuit board or ribbon 10 and connector 100 is established and maintained.

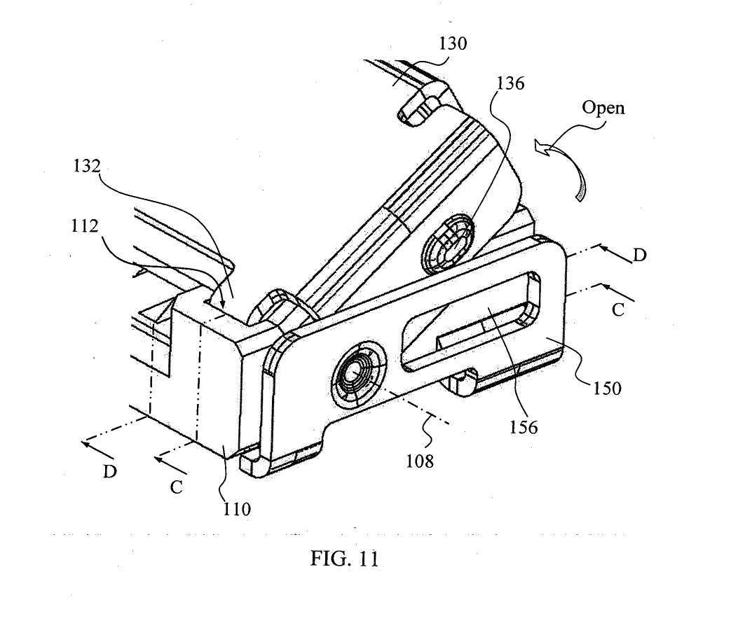

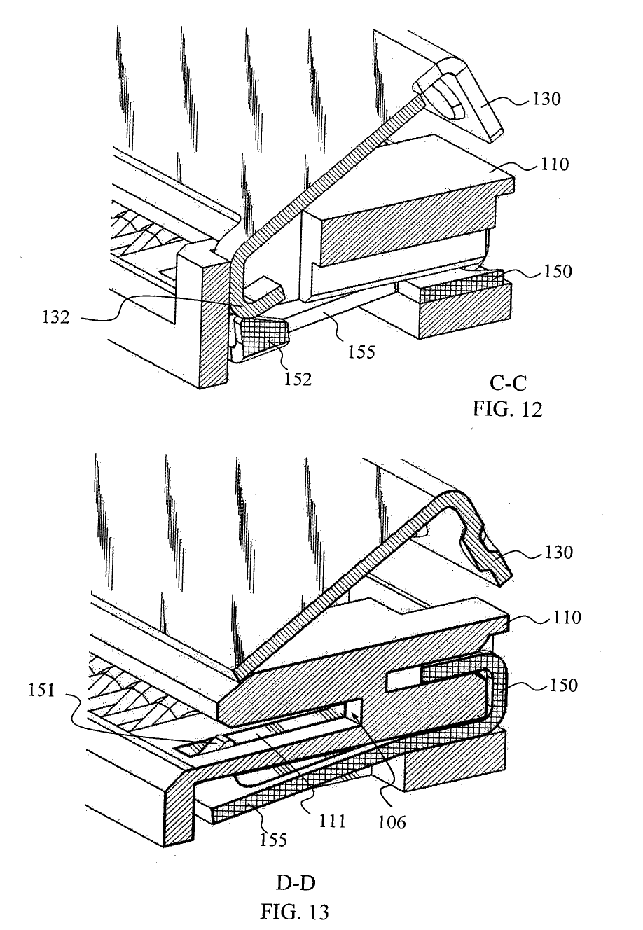

When it is desired to remove flexible/flat circuit board or ribbon 10 from connector 100, e.g. during a repair or replacement process, shield 130 is rotated to the open position as shown in FIGS. 10 and 11 by overcoming the engagement force between locking boss 136 and locking support 156. Rotation of shield 130, to the open position forces releasing members 132, by the engagement with rear-faced inclined surface of releasing member 132, to move further into releasing opening 112. As shown in FIGS. 12 and 13, when shield 130 is at the open position, each releasing member 132 presses against a corresponding release projection 152 of locking member 155, and causes locking member 155 to deflect downwardly. As locking projection 151 and release projection 152 are formed integral on locking member 155, locking projections 151 follow the deflection of locking member 155 and move out of opening 15 of flexible flat circuit board or ribbon 10. As such, the engagement between flexible/flat circuit board or ribbon 10 and locking projection 151 is removed and flexible/flat circuit board or ribbon 10 is allowed to be detached from connector 100.

When shield 130 rotates to the close position, the pressure added to release projections 152 by releasing members 132 is reduced and then removed. Due the resilient nature, locking members 155 spring back to their original position by which, locking projections 151 resume their position in cavity 106.

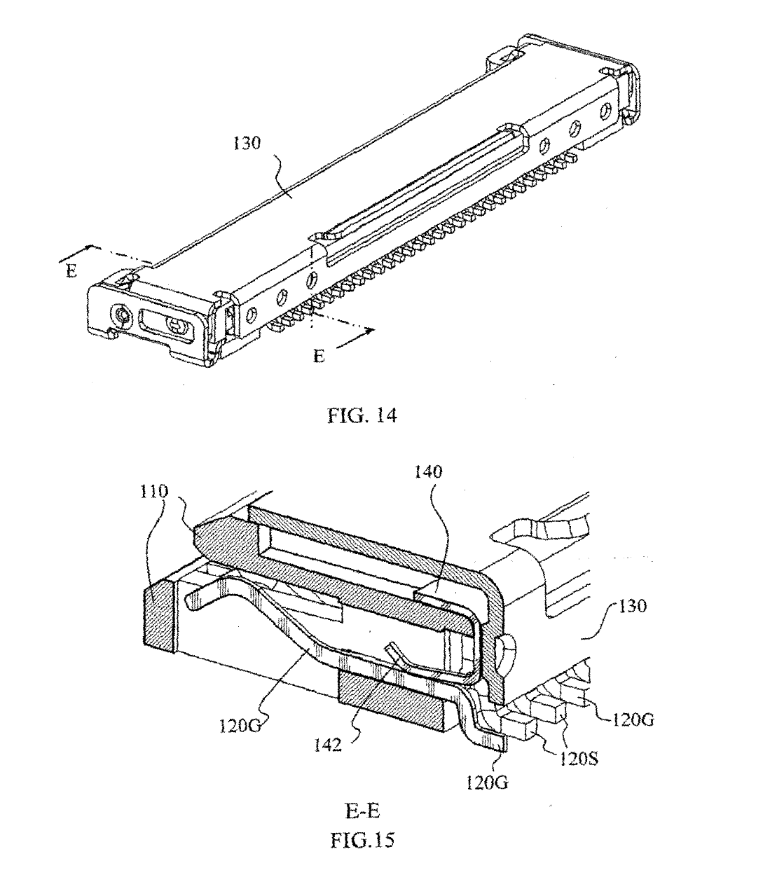

FIGS. 2, 14 and 15 show detailed positional relationship between housing 110, contacts 120, shield 130 and ground bar 140. Contacts 120 include ground terminals 120G and signal terminals 120S, positioned in an alternate manner, i.e. with one pair of signal contacts 120S disposed between two ground terminals 120G. Ground bar 140 is attached to housing 110 and with each ground finger 142 positioned in contact with one ground terminal 120G. In this way, all the grounding terminals 120G are electrically connected together to ground bar 140.

When at the close position, shield 130 is engaged to and in electrical contact with ground bar 140. Ground bar 140 and shield 130 therefore provide a common ground for all the ground contacts 120G, hence the shielding effect of the connector is enhanced and signal transmission speed can be improved.

Additionally, when at the close position, shield 130 acts against ground bar 140 from outside of the connector. This engagement effectively secures ground bar in position and to prevent ground bar 140 from being detached from housing 110.

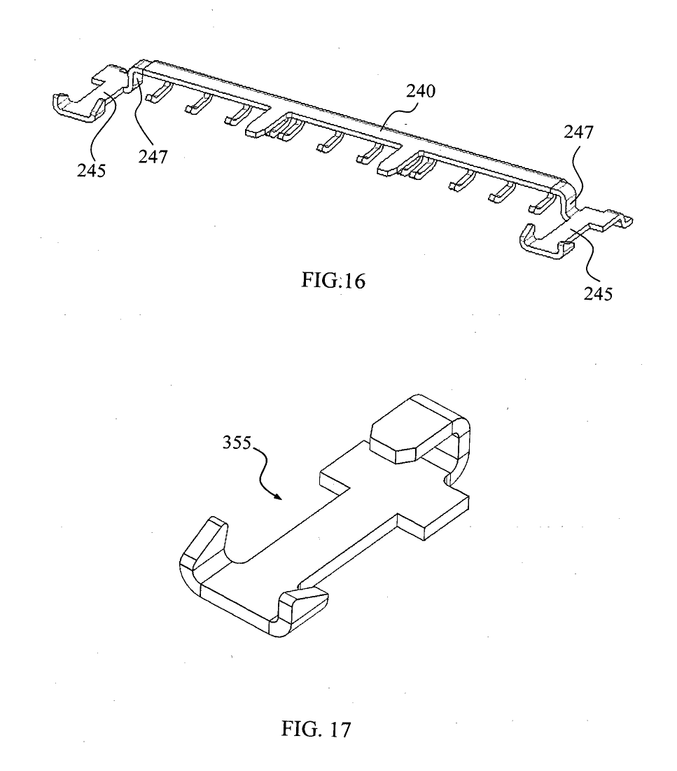

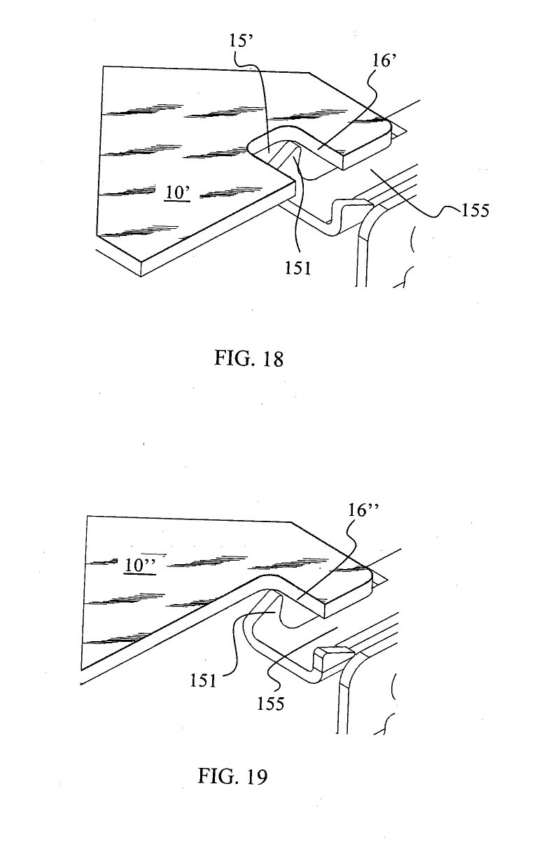

Although embodiments of the present invention have been illustrated in conjunction with the accompanying drawings and described in the foregoing detailed description, it should be appreciated that the present invention is not limited to the embodiments disclosed. For example, as shown in FIG. 16, in a flexible circuit connector according to another embodiment of the present invention, locking members 245 and ground bar 240 are formed as an integral part. Each locking member 245 is connected to ground bar by a corresponding link piece 247. This embodiment provides connector manufacturers with alternative solutions to design a connector which maybe suitable for different manufacturing environments. According to a further embodiment, a locking member 355 may not be part of either the fixing tab or the ground bar, but stand-alone parts attached by post-insertion or insert-molded to the housing to lock the flexible/flat circuit board or ribbon, as shown in FIG. 17. Additionally, as shown in FIGS. 18 and 19, embodiments of the present invention provide connectors to which various types of flexible/flat circuit board or ribbon 10′, 10″ may be connected. In FIG. 17, flexible/flat circuit board or ribbon 10′ has a pair of notches 15′ (only one is shown), each forming a shoulder 16′ for engaging to locking projection 151 of locking member 155. In FIG. 18, flexible/flat circuit board or ribbon 10″ has a pair of lateral projections 16″ (only one is shown) which engage to locking projection 151 of locking member 155. Therefore, the present invention should be understood to be capable of numerous rearrangements, modifications, alternatives and substitutions without departing from the spirit of the invention as set forth and recited by the following claims.

1. An electrical connector for connecting to a circuit board, the electrical connector comprising:
a housing having a cavity defined therein, the cavity is to receive therein an end portion of the circuit board inserted from a front side of the housing;
contacts disposed in the housing for connecting to the circuit board;
a shield mounted to the housing, the shield is rotatable relative to the housing between a close position and an open position;
a pair of locking members attached to the housing, each locking member having a holding piece fixed to the housing, a locking projection and a release projection resiliently deflectable relative to the holding piece;
wherein when the shield is at the close position, the locking projection is positioned in the cavity and when the shield is at the open position, the shield deflects the locking member to move the locking projection away from the cavity.

2. The electrical connector of claim 1, wherein when moving towards the open position, the shield urges against the release projection to deflect the locking member to move the locking projection away from the cavity.

3. The electrical connector of claim 2, wherein the release projection has an inclined surface contacting the shield when the shield moves towards the open position.

4. The electrical connector of claim 2, wherein the release projection is positioned outside of the cavity.

5. The electrical connector of claim 2, wherein the shield has a pair of releasing members each being disposed in a release opening form on the housing, wherein when the shield rotates, the releasing members are movable within the release opening.

6. The electrical connector of claim 1, wherein the locking projection of each of the locking members has an inclined surface facing the front side of the housing such that when a circuit board is inserted into the cavity, the circuit board urges against the inclined surface to move the locking projection out of the cavity.

7. The electrical connector of claim 1, wherein the housing has a pair of protuberances projecting outwardly therefrom, and wherein the shield has a middle portion and a pair of sidewalls bent perpendicularly from the middle portion, each sidewall has a pivot bearing engaged to a corresponding protuberance to support rotation of the shield.

8. The electrical connector of claim 7, further comprising a pair of support plates attached to the housing, each support plate being formed integral to one of the pair of locking members, wherein each support plate has a pivot support in alignment with a corresponding pivot protuberance to form a pivot shaft to support rotation of the shield.

9. The electrical connector of claim 7, wherein each support plate has an opening formed thereon and the shield has a pair of locking bosses each being formed on one of the pair of sidewalls, wherein when the shield is at the close position, each of the locking bosses is disposed in a corresponding opening.

10. The electrical connector of claim 1, wherein the contacts includes signal terminals and ground terminals, wherein the connector further comprising a ground bar attached to the housing and in electrical connection with the ground contact terminals, wherein the ground bar is formed integral to the pair of locking members.

11. The electrical connector of claim 10, wherein at the close position the shield engages the ground bar to prevent the ground bar from being detached from the housing.

12. An electrical connection assembly comprising:
an electrical connector as recited in claim 1,
a circuit board having a front portion and a pair of openings formed thereon, the front portion being disposed in the cavity and each of the locking projections of the locking member engages a corresponding one of the pair of openings to prevent the circuit board from being retrieved from the housing.
